(19) United States
(12) Patent Application Publication
(10) Pub. No.: US 2009/0021168 A1
(43) Pub. Date: Jan. 22, 2009

(54) Plasma display panel

(76) Inventor: Jung-Suk Song, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/213,978

(22) Filed: Jun. 26, 2008

(30) Foreign Application Priority Data
Jul. 18, 2007 (KR) 10-2007-0071705

(51) Int. Cl. H01J 17/49

(52) U.S. Cl. 313/582

(57) ABSTRACT

A plasma display panel (PDP) including front and rear substrates disposed to face each other, a frit inserted between overlapping areas of the front and rear substrates, a display area adapted to implement an image in at least a portion of the overlapping areas, and a non-display area at another portion of the overlapping areas other than the display area, the non-display area including a first dummy barrier rib at an inner side of the frit, and a second dummy barrier rib at an outer side of the frit.

### BACKGROUND OF THE INVENTION

1. Field of the Invention

Embodiments relate to a plasma display panel (PDP) and, more particularly, to a plasma display panel capable of reducing and/or preventing misfiring at a display area adjacent to a non-display area and reducing noise at the non-display area adjacent to the display area.

2. Description of the Related Art

In general, in PDPs, plasma is generated by a gas discharge and phosphor is excited by vacuum ultra-violet (VUV) ray(s) radiated from the plasma. As the excited phosphor is stabilized, visible light of red (R), green (G) and blue (B) is generated to implement images.

For example, an AC type PDP includes a front substrate and a rear substrate, which are attached in a facing manner. Address electrodes are formed on the rear substrate and covered by a dielectric layer.

Barrier ribs are disposed in a striped pattern between address electrodes on the dielectric layer. Red (R), green (G), and blue (B) phosphor layers are formed on inner surfaces of the barrier ribs.

Display electrodes are formed as a pair of a sustain electrode and a scan electrode, and the sustain electrode and the scan electrode are formed on the front substrate and covered by a dielectric layer and an MgO protective layer.

When the front and rear substrates are attached with the barrier ribs interposed therebetween, the address electrodes on the rear substrate and the display electrodes on the front substrate overlap and/or cross each other.

Discharge cells are formed at each overlapping and/or crossing region of the address electrodes and the display electrodes. Accordingly, such PDPs may include more than millions of unit discharge cells arranged in a matrix form therein.

In addition, PDPs generally include a display area where desired image(s) may be implemented and a non-display area, corresponding to a portion of the PDP other than where desired image(s) may be implemented.

At the non-display area, the front and rear substrates are supported by dummy barrier ribs that maintain a gap therebetween, and bonded by a frit provided on an outer edge portion of the dummy barrier ribs. Thus, the gap between the front and rear substrates is smaller at the portion corresponding to the frit than at the display area.

In such PDPs, the front substrate may bend forward, i.e., have a forwardly protruding shape, at a portion corresponding to the dummy barrier ribs, In such cases, the front substrate may protrude so as to come off from, i.e., separate from, the dummy barrier ribs.

Thus, in such PDPs, the display area adjacent to the non-display area experiences misfiring(s) and/or a relatively high amount of noise exists in a vicinity of the dummy barrier ribs adjacent to the display area.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the invention are therefore directed to plasma display panels (PDPs), which substantially overcome one or more of the problems due to the limitations and disadvantages of the related art.

It is therefore a feature of an embodiment of the invention to provide a plasma display panel (PDP) capable of reducing and/or preventing misfiring(s) at a display area adjacent to a non-display area.

It is therefore a feature of an embodiment of the invention to provide a plasma display panel (PDP) capable of reducing noise at the non-display area adjacent to the display area.

At least one of the above and other features and advantages of the invention may be realized by providing A plasma display panel (PDP), including front and rear substrates disposed to face each other; a frit inserted between overlapping areas of the front and rear substrates, a display area adapted to implement an image in at least a portion of the overlapping areas; and a non-display area at another portion of the overlapping areas other than the display area, the non-display area including a first dummy barrier rib at an inner side of the frit, and a second dummy barrier rib at an outer side of the frit.

A first distance between the first dummy barrier rib and the frit may be smaller than a second distance between the frit and the second dummy barrier rib.

A first gap between the front and rear substrates near the first dummy barrier rib may have a same size as a second gap between the front and rear substrates near the second dummy barrier rib.

The second dummy barrier rib may be arranged at an outermost edge portion of the overlapping areas.

The PDP may further include a plurality of at least one of the first dummy barrier ribs, wherein a number of the plurality of first dummy barrier ribs may be greater than a number of the second dummy barrier ribs.

The PDP may further include a second frit arranged outside the second dummy barrier rib between overlapping areas of the front and rear substrates.

The frit may have a first width that is smaller than a second width of the second frit.

The second frit may be arranged at an outermost edge portion of the overlapping areas.

The frit may have a first height between the front and rear substrates and the second frit may have a second height between the front and rear substrates, and the first height may be a same as the second height.

Each of the frit and the second frit may completely surround the display area and respective portions of the non-display area between the front and rear substrates.

The PDP may further include a first dielectric/protective layer on electrodes on the rear substrate and a second dielectric/protective layer on electrodes on the front substrate, wherein the frit and the second frit completely extend between the first dielectric/protective layer on the rear substrate and the second dielectric/protective layer on the front substrate.

The non-display area may be at an outer edge portion of the display area.

At least one of the above and other features and advantages of the invention may be separately realized by providing a plasma display panel (PDP), including front and rear substrates disposed to face each other, a frit inserted between overlapping areas of the front and rear substrates, a display area adapted to implement an image at the overlapping areas, and a non-display area at an outer edge portion of the display area, wherein the frit includes a first frit member at the non-display area, and a second frit member at an outer side of the first frit member, and the non-display area includes a first dummy barrier rib at an inner side of the first frit member and a second dummy barrier rib between the first and second frit members.

The second frit member may be disposed at the outermost edge portion of the non-display area.

A first width of the first frit member may be smaller than a second width of the second frit member.

A first gap between the front and rear substrates near the first frit member may be larger than a second gap between the front and rear substrates near the second frit member.

A number of first dummy barrier ribs may be larger than a number of the second dummy barrier ribs.

A first area where the first dummy barrier ribs are arranged may be larger than a second area where the second dummy barrier ribs are arranged.

The second frit member may completely surround the display area and a portion of the non-display area between the front and rear substrates.

The first frit member may completely surround the display area and a respective portion of the non-display area between the front and rear substrates.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates an exploded perspective view of an exemplary embodiment of a plasma display panel (PDP);

FIG. 2 illustrates a cross-sectional view of the PDP of FIG. 1, taken along line II-II in FIG. 1;

FIG. 3 illustrates a top plan view of an exemplary arrangement of barrier ribs and electrodes;

FIG. 4 illustrates a top plan view of rear and front substrates of FIG. 1 including a frit coated therebetween;

FIG. 5 illustrates a cross-sectional view of the PDP of FIG. 1, taken along line V-V of FIG. 4 according to a first exemplary embodiment of the invention; and

FIG. 6 illustrates a cross-sectional view of the PDP of FIG. 1, taken along line V-V in FIG. 4 according to a second exemplary embodiment of the invention.

### DETAILED DESCRIPTION OF THE INVENTION

Korean Patent Application No. 10-2007-0071705, filed on Jul. 18, 2007, in the Korean Intellectual Property Office, and entitled: “Plasma Display Panel,” is incorporated by reference herein in its entirety.

Exemplary embodiments of the invention will be described more fully hereinafter with reference to the accompanying drawings, in which exemplary embodiments of the invention are illustrated. As those skilled in the art would realize, the described embodiments may be modified in various different ways, all without departing from the spirit or scope of the present invention. In order to clarify the present invention, parts that are not related to descriptions are omitted, and the same or similar elements are given the same reference numerals throughout the specification.

In the figures, the dimensions of layers and regions may be exaggerated for clarity of illustration. It will also be understood that when an element is referred to as being “on” another element, it can be directly on the other element, or intervening elements may also be present. In addition, it will also be understood that when an element is referred to as being “between” two elements, it can be the only layer between the two elements, or one or more intervening elements may also be present.

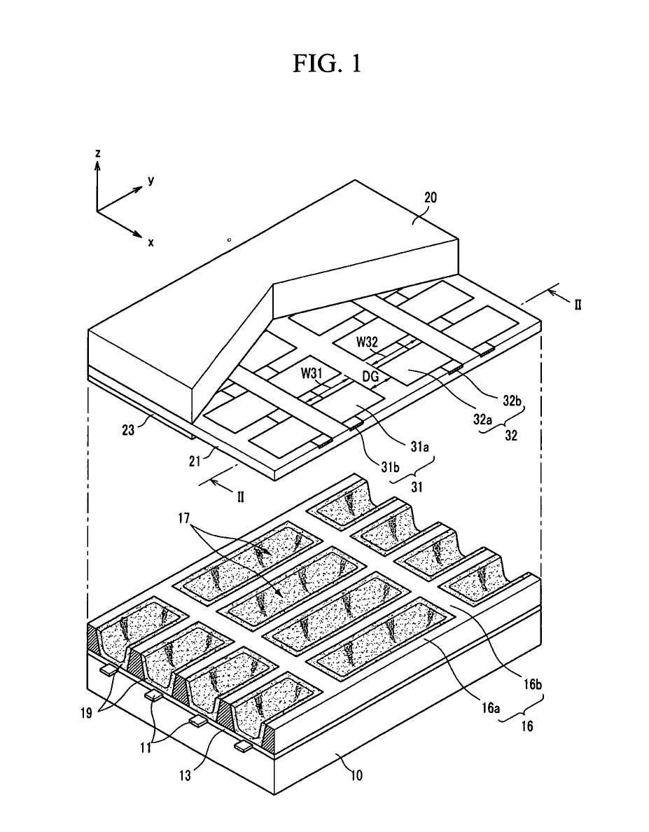

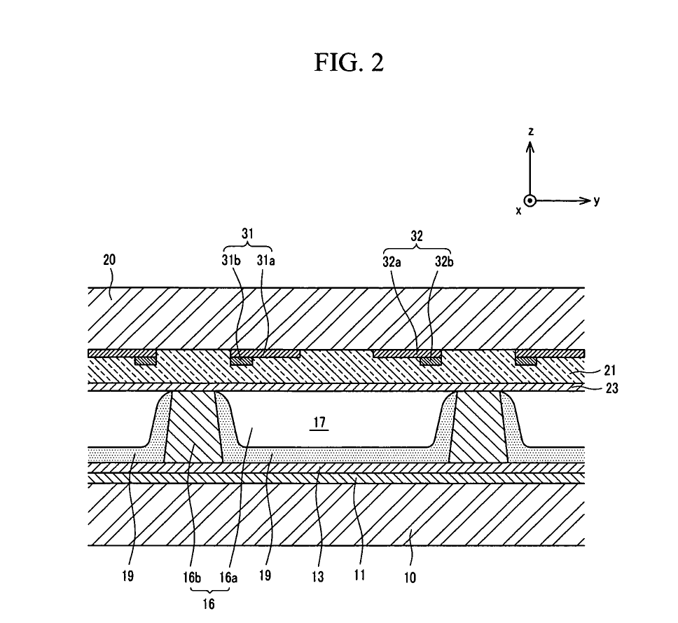

FIG. 1 illustrates an exploded perspective view of a plasma display panel (PDP) according to a first exemplary embodiment of the present invention, and FIG. 2 illustrates a cross-sectional view of the PDP of FIG. 1, taken along line II-II in FIG. 1.

With reference to FIGS. 1 and 2, the PDP, according to the first exemplary embodiment of the present invention, may include a first substrate (referred to as ‘rear substrate’, hereinafter) 10 and a second substrate (referred to as ‘front substrate’, hereinafter) 20. The rear substrate 10 and the front substrate 20 may be disposed to face each other with a pre-set gap therebetween. The rear substrate 10 and the front substrate 20 may be sealed together.

Barrier ribs 16 may be formed with a pre-set height to partition a plurality of discharge cells 17 between the rear substrate 10 and the front substrate 20. The discharge cells 17 may be filled with a discharge gas, e.g., a mixture gas containing neon (Ne) and xenon (Xe), etc., to generate vacuum ultraviolet (VUV) rays according to a gas discharge. The discharge cells 17 may include phosphor layers 19 that may absorb the VUV rays to emit visible light.

In order to implement images through the gas discharge, the PDP may include address electrodes 11, first electrodes (referred to as ‘sustain electrodes’, hereinafter) 31 and second electrodes (referred to as ‘scan electrodes’, hereinafter) 32. Respective portions of the address, sustain and scan electrodes 11, 31, 32 may correspond to the respective discharge cells 17.

For example, the address electrodes 11 may be formed to extend along a first direction, i.e., along a y-axis direction in FIG. 2, on an inner surface of the rear substrate 10. Respective adjacent portions of the address electrodes 11 may correspond to the adjacent discharge cells 17 in the y-axis direction. The address electrodes 11 may be disposed parallel to each other, such that adjacent ones of the address electrodes 11 may correspond to adjacent ones of the discharge cells 17 along a second direction, i.e., along an x-axis direction, which crosses the y-axis direction.

A first dielectric layer 13 may be formed on the inner surface of the rear substrate 10 such that it covers the address electrodes 11. When discharge occurs, the first dielectric layer 13 prevents positive ions or electrons from directly colliding with the address electrodes 11 to thereby protect the address electrodes 11 and provide a space to allow wall charges to be formed and accumulated.

In some embodiments, the address electrodes 11 may be disposed on the rear substrate 10. In such embodiments, the address electrodes 11 do not to interfere with illumination of visible light in a forward direction, and the address electrodes 11 may be formed as opaque electrodes, i.e., metal electrodes with good electrical conductivity such as silver (Ag).

The barrier ribs 16 may be formed on the first dielectric layer 13 of the rear substrate 10 to partition the discharge cells 17. For example, the barrier ribs 16 may include first barrier rib members 16a and second barrier rib members 16b to at least partially define the discharge cells 17. In such embodiments, the discharge cells may be arranged in a matrix form.

In such embodiments, e.g., the first barrier rib members 16a may be formed to extend in the Y-axis direction and may be disposed at pre-set intervals along the x-axis direction. The second barrier rib members 16b may be disposed at pre-set intervals in the y-axis direction between adjacent ones of the first barrier rib members 16a and may extend in the x-axis direction.

Embodiments are not limited thereto. For example, in some embodiments, barrier ribs may include first barrier rib members formed to extend in the y-axis direction, and these first barrier rib members may be disposed side by side along the x-axis direction to at least partially define discharge cells formed in a striped-like pattern (not illustrated).

In some embodiments, the phosphor layers 19 may be formed by coating phosphor paste on respective sides of the barrier ribs 16 and on a respective surface of the first dielectric layer 13 surrounded by the barrier ribs 16. The phosphor paste may be dried and baked to form the phosphor layers 19.

The phosphor layers 19 may be formed so as to generate visible light of the same color from the discharge cells 17 formed along the y-axis direction. More particularly, e.g., the phosphor layers 19 may be formed such that red (R), green (G) and blue (B) phosphor layers 19 may be repeatedly disposed to generate visible light of red (R), green (G) and blue (B) with respect to the discharges cells 17 that are continually disposed along the x-axis direction.

The sustain electrodes 31 and the scan electrodes 32 may have a surface discharge structure. The sustain electrodes 31 and the scan electrodes 32 may be formed on an inner surface of the front substrate 20. Respective portions of the sustain electrodes 31 and the scan electrodes 32 may correspond to the respective ones of the discharge cells 17 to cause a gas discharge from the respective discharge cells 17.

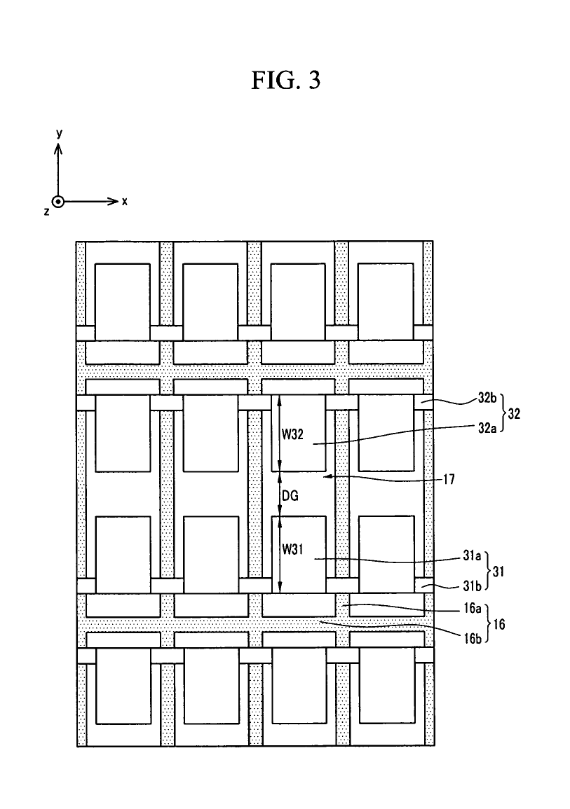

FIG. 3 illustrates a top plan view of an exemplary arrangement of the barrier ribs 16 and the sustain and scan electrodes 31, 32. With reference to FIG. 3, the sustain electrodes 31 and the scan electrodes 32 may extend along the x-axis direction, crossing and/or overlapping the address electrodes 11.

The sustain electrodes 31 and the scan electrodes 32 may include transparent electrodes 31a and 32a that generate discharges and bus electrodes 31b and 32b that apply voltage signals to the transparent electrodes 31a and 32a, respectively.

The transparent electrodes 31a and 32a, which may correspond to portions where surface discharges occur within the discharge cells 17, are made of a transparent material, e.g., ITO (Indium Tin Oxide), in order to secure an aperture ratio of the discharge cells 17. The bus electrodes 31b and 32b may be made of a metallic material with good electrical conductivity in order to compensate for the relatively high electrical resistance of the transparent electrodes 31a and 32a.

The transparent electrodes 31a and 32a may protrude, toward central portions of the respective discharge cells 17, from outer edges of the respective discharge cells 17 along the y-axis direction to form the surface discharge structure with respective widths W31 and W32. A discharge gap DG may be formed at a central portion of each discharge cell.

The bus electrodes 31b and 32b may be disposed on the transparent electrodes 31a and 32a and may elongate in the x-axis direction from the outer edges of the respective discharge cells 17. Accordingly, when a voltage signal is applied to the bus electrodes 31b and 32b, a voltage signal may be applied to the transparent electrodes 31a and 32a connected with the bus electrodes 31b and 32b, respectively.

Referring back to FIGS. 1 and 2, a second dielectric layer 21 may be formed on the inner surface of the front substrate 20 and may cover the sustain electrodes 31 and the scan electrodes 32. The second dielectric layer 21 may protect the sustain electrodes 31 and the scan electrodes 32 against a gas discharge and may provide a space allowing wall charges to be formed and accumulated during discharging.

A protective layer 23 may cover the second dielectric layer 21. For example, the protective layer 23 may include transparent MgO that protects the second dielectric layer 21, and increases a secondary electron emission coefficient during discharging.

When the PDP is driven, during a reset period, a reset discharge may occur based on reset pulses applied to the scan electrodes 32. During an address period that follows the reset period, an address discharge may occur based on scan pulses applied to the scan electrodes 32 and address pulses applied to the address electrodes 11. Thereafter, during a sustain period, a sustain discharge may occur based on sustain pulses applied to the sustain electrodes 31 and the scan electrodes 32.

The sustain electrodes 31 and the scan electrodes 32 may serve to apply the sustain pulses required for the sustain discharge. The scan electrodes 32 may serve to apply the reset pulses and the scan pulses. The address electrodes 11 may serve to apply the address pulses. The sustain electrodes 31, the scan electrodes 32, and the address electrodes 11 may have different roles, respectively, depending on voltage waveforms applied thereto. Embodiments are not limited to the above-described roles.

In the PDP, discharge cells 17 to be turned on may be selected by address discharge according to an interaction between the corresponding respective portions of the address electrodes 11 and the scan electrodes 32. Discharge cells 17 selected by the sustain discharge according to interaction of the sustain electrodes 31 and the scan electrodes 32 may be driven to implement images.

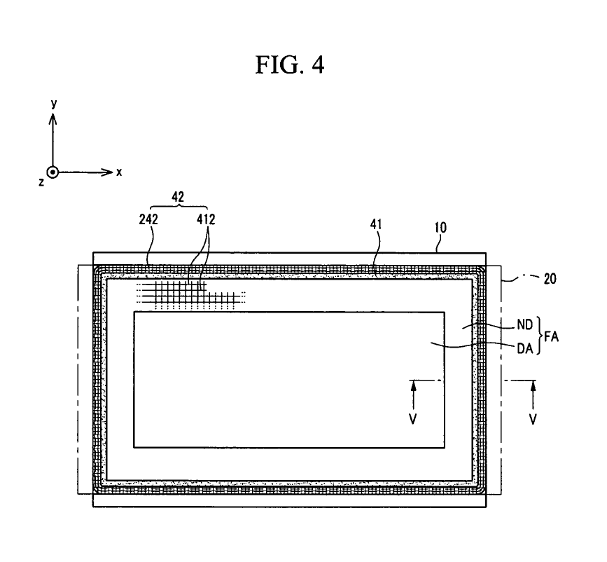

FIG. 4 illustrates a top plan view of rear and front substrates of FIG. 1 including a frit coated therebetween.

Referring to FIG. 4, in some embodiments, the rear and front substrates 10 and 20 may overlap with each other. In such embodiments, opposing sides of the front rear substrate 10 may protrude from outer edges of the front substrate 20 in the y-direction, while opposing sides of the rear substrate 20 may protrude from outer edges of the rear substrate 10 along the x-direction. Frit 41 may be interposed between overlap areas FA to seal the rear and front substrates 10 and 20.

For example, the frit 41 may be formed as a line along outer edge portions of the overlap area FA to seal the rear and front substrates 10 and 20. The overlap area FA is isolated from the exterior by the frit 41.

The overlap area FA may be divided into a display area DA and a non-display area ND. The display area DA is an area where images are to be displayed, and the non-display area ND is where images are not intended to be displayed. In some embodiments, the non-display area ND may be formed at an outer edge portion of the display area DA.

Dummy barrier ribs 42 may be formed at the non-display area ND. The dummy barrier ribs 42 may support the rear and front substrates 10 and 20 as sealed.

Wall charges may move between the dummy barrier ribs 42 adjacent to the display area DA and the barrier ribs 16 of the display area DA. Thus, the discharge cells 17 of the display area DA adjacent to the non-display area ND may normally perform discharging and implement an image like the discharge cells 17 surrounded by the display area DA.

At least a portion of the non-display area ND may correspond to an area where element(s) for applying a voltage signal(s) required for the sustain electrodes 31, the scan electrodes 32 and the address electrodes 11 may be arranged. The element(s) for applying the voltage signal(s) is not related to the present invention, so its description will be omitted.

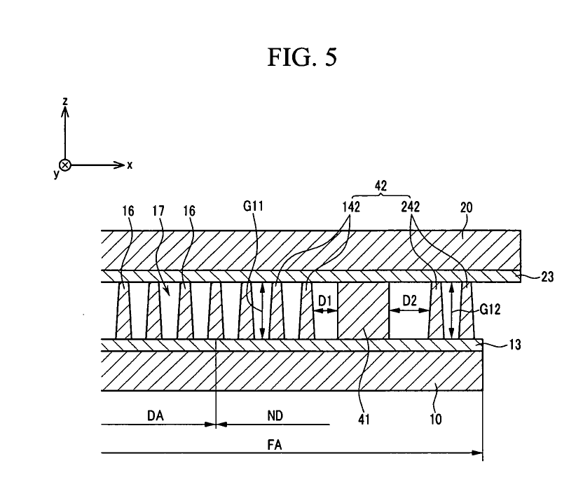

FIG. 5 illustrates a cross-sectional view of the PDP of FIG. 1, taken along line V-V of FIG. 4 according to a first exemplary embodiment of the invention.

With reference to FIG. 5, the dummy barrier ribs 42 provided at the non-display area ND may include first dummy barrier rib members 142 and second dummy barrier rib members 242.

The first dummy barrier rib members 142 may be formed at an inner side of the frit 41. One or a plurality of the first dummy barrier rib members 142 may be formed between the display area DA and the frit 41.

The second dummy rib members 242 may be formed at an outer side of the frit 41. One or a plurality of the second dummy barrier rib members 242 may be formed at the outer side of the frit 41.

In some embodiments, the second dummy barrier rib members 242 may be formed at an outermost edge portion of the overlap areas FA. Respective ones of the second dummy barrier rib members 242 may support two shorter sides of the rear substrate 10 and two longer sides of the front substrate 20 (refer to FIG. 4).

More particularly, in some embodiments, in supporting the rear and front substrates 10 and 20, the first dummy barrier rib members 142 may support the front and rear substrates 10 and 20 at the inner side of the frit 41 of the non-display area ND and the second dummy barrier rib members 242 may support the front and rear substrates 10 and 20 at the outer side of the frit 41.

In the sealed state, the front and rear substrates 10 and 20 supported by the barrier ribs 16 and the first dummy barrier rib members 142 may be pulled to each other by the frit 41. The second dummy barrier rib members 242 may support the rear and front substrates 10 and 20 at the opposite side of the first dummy barrier rib members 142 based on the frit 41.

The second dummy barrier rib members 242 may have a same height as that of the first dummy barrier rib members 142. Accordingly, the rear and front substrates 10 and 20 may maintain a gap corresponding to the height of the first dummy barrier rib members 142 even at outer edge portions of the frit 41.

Thus, in some embodiments, the rear and front substrates 10 and 20 may be maintained to be parallel near the first and second dummy barrier rib members 142 and 242. In some embodiments, e.g., the front substrate 20 does not separate from the rear substrate 10 at the first dummy barrier ribs 142 and/or does not bend so as to protrude further forward at the first dummy barrier ribs 142. In some embodiments, e.g., one or both of the rear and front substrates 10, 20 may not bend away from and/or separate from the first and second dummy barrier rib members 142, 242.

Referring to FIG. 5, a first distance D1 may be a distance between the first dummy barrier rib member 142 and the frit 41 and a second distance D2 may be a distance between the second dummy barrier rib member 242 and the frit 41. In some embodiments, the second distance D2 may be smaller than the first distance D2.

In some embodiments, the second distance D2 may be larger than the first distance based on the frit 41. In such embodiments, a smaller number of the second dummy barrier rib members 242 than a number of the first dummy barrier rib members 142 may support the rear and front substrates 10 and 20 in a parallel manner.

Referring to FIG. 5, the gap may be formed between the rear and front substrates 10 and 20 by the barrier ribs 16 and the dummy barrier ribs 42. A first gap G11 may be formed near the first dummy barrier rib member 142, and a second gap G12 may be formed near the second dummy barrier rib member 242.

In some embodiments, the first gap G11 may be substantially and/or completely the same as the second the gap G12. That is, e.g., in some embodiments, the second dummy barrier rib members 242 may support respective end portions of the rear and front surfaces 10 and 20 such the first and second gaps G11 and G12 may have the same size. Accordingly, embodiments of the invention may enable misfiring at the display area DA adjacent to the non-display area ND to be reduced and/or prevented, and noise at the non-display area ND adjacent to the display area DA to be reduced.

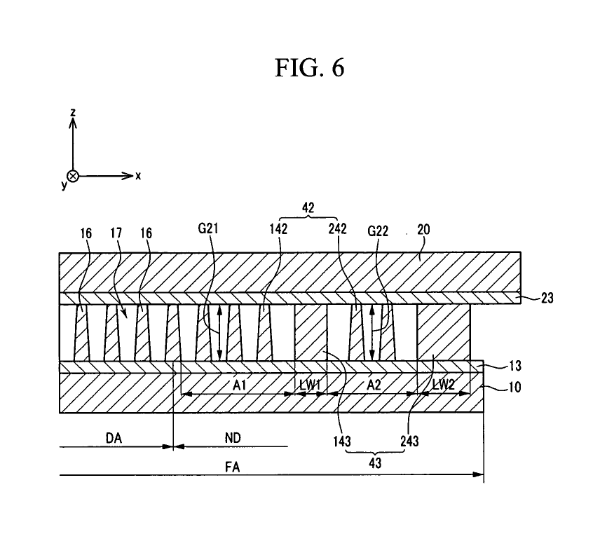

FIG. 6 illustrates a cross-sectional view of the PDP of FIG. 1, taken along line V-V in FIG. 4 according to a second exemplary embodiment of the invention.

The second exemplary embodiment of the present invention illustrated in FIG. 6 is the same as or similar to the first exemplary embodiment of the present invention illustrated in FIG. 5, so a description on the similar or same parts will be omitted and, in general, only differences therebetween will be described.

With reference to FIG. 6, in the second exemplary embodiment, frits 43 are employed instead of frit 41. The frits 43 may include a first frit member 143 and a second frit member 243. The first frit member 143 may be formed at an inner portion of the non-display area ND adjacent to the display area DA, and the second frit member 243 may be formed at an outer side of the first frit member 143.

That is, e.g., compared with the first exemplary embodiment of FIG. 5, the second exemplary embodiment of the present invention additionally includes the second frit member 243. However, embodiments of the invention are not limited thereto. The first dummy barrier rib members 142 may be formed at an inner side of the first frit member 143. The second dummy barrier rib members 242 may be formed between the first and second frit members 143 and 243.

The second frit member 243 may be formed at an outermost edge portion of the non-display area ND. The first frit member 143 may have a first line width LW1 and the second frit member 243 may have a second line width LW2. The first frit member 143 may seal the rear and front substrates 10 and 20 between the first and second dummy barrier rib members 142 and 242. The second frit member 243 may seal the rear and front substrates 10 and 20 at an outer side of the second dummy barrier rib members 242. In some embodiments, the second frit member 243 may seal the both substrates 10 and 20 at the outermost edge portion of the overlap areas FA.

In some embodiments, the first line width LW1 of the first frit member 143 may be smaller than the second line width LW2 of the second frit member 243.

In some embodiments, the front and rear substrates 20 and 10 may be mainly sealed by virtue of the second frit member 243. The first frit member 143 may help seal the front and rear substrates 20 and 10 near the first dummy barrier ribs 142, and may further help prevent the front substrate 20 from being separated to reduce and/or prevent misfiring at the display area DA.

Referring to FIG. 6, between the front and rear substrates 20 and 10, a first gap G21 may be formed near the first frit member 143 and a second gap G22 may be formed near the second frit member 243. In some embodiments, the first gap G21 may be exactly or substantially the same as the second gap G22. In some embodiments, an adhesive force of the second frit member 243 may be stronger than that of the first frit member 143. In such embodiments, e.g., the first gap G21 may be slightly larger than the second gap G22, however, such a difference may be very small, so the first and second gaps G21 and G22 are illustrated in FIG. 6 as having the same size.

A first area A1 where the first dummy barrier rib members 142 are formed may be larger than a second area A2 where the second dummy barrier rib members 242 are formed. The first area A1 may be reduced with the first frit member 143 and may thereby reduce noise.

Wall charges may move between the first dummy barrier rib members 142 of the first area A1 and the barrier ribs 16 of the display area DA. Thus, the discharge cells 17 of the display area DA adjacent to the non-display area ND may normally perform discharging and implement an image like the discharge cells 17 surrounded by the display area DA. Thus, misfiring at the display area DA adjacent to the non-display area ND may be reduced.

The second dummy barrier rib members 242 at the second area A2 may support the both substrates 10 and 20 between the first and second frit members 143 and 243. Thus, the second dummy barrier rib members 242 at the second area A2 may minimize a space between the substrates 10, 20 and may thereby reduce noise.

In some embodiments, the first and second dummy barrier rib members 142 and 242 may be formed as barrier rib members that cross each other like the first and second barrier rib members 16a and 16b. However, embodiments are not limited thereto. For example, the first and second dummy barrier rib members 142, 242 may be formed as a single barrier rib member.

As described above, embodiments of one or more aspects of the invention may provide a PDP in which first dummy barrier ribs are formed at an inner side of a first frit at a non-display area and second dummy barrier ribs are formed at an outer side of the first frit. Embodiments of one or more aspects of the invention may provide a PDP in which a front substrate will not come off, i.e., separate from a second substrate, near a first frit. Embodiments of one or more aspects of the invention may provide a PDP in which a first gap near a first dummy barrier rib and a second gap near a second dummy barrier rib are the substantially and/or completely the same between front and rear substrates. In some embodiments in which a first gap between relatively inner portions of front and rear substrates is larger than a second gap between relatively outer portions of the front and rear substrates, a second frit may be additionally provided at edge portions, e.g., outermost edge portions, of the non-display area. Thus, embodiments may provide PDPs in which misfiring in a display area adjacent to a non-display area may be reduced and/or prevented. Embodiments may separately provide PDPs in which noise at a non-display area adjacent to a display area may be reduced.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
front and rear substrates disposed to face each other;
a frit inserted between overlapping areas of the front and rear substrates;
a display area adapted to implement an image in at least a portion of the overlapping areas; and
a non-display area at another portion of the overlapping areas other than the display area, the non-display area including:
a first dummy barrier rib at an inner side of the frit, and
a second dummy barrier rib at an outer side of the frit.

2. The PDP as claimed in claim 1, wherein a first distance between the first dummy barrier rib and the frit is smaller than a second distance between the frit and the second dummy barrier rib.

3. The PDP as claimed in claim 1, wherein a first gap between the front and rear substrates near the first dummy barrier rib has a same size as a second gap between the front and rear substrates near the second dummy barrier rib.

4. The PDP as claimed in claim 1, wherein the second dummy barrier rib is arranged at an outermost edge portion of the overlapping areas.

5. The PDP as claimed in claim 1, further comprising a plurality of at least one of the first dummy barrier ribs, wherein a number of the plurality of first dummy barrier ribs is greater than a number of the second dummy barrier ribs.

6. The PDP as claimed in claim 1, further comprising a second frit arranged outside the second dummy barrier rib between overlapping areas of the front and rear substrates.

7. The PDP as claimed in claim 6, wherein the frit has a first width that is smaller than a second width of the second frit.

8. The PDP as claimed in claim 6, wherein the second frit is arranged at an outermost edge portion of the overlapping areas.

9. The PDP as claimed in claim 6, wherein the frit has a first height between the front and rear substrates and the second frit has a second height between the front and rear substrates, and the first height is a same as the second height.

10. The PDP as claimed in claim 6, wherein each of the frit and the second frit completely surrounds the display area and respective portions of the non-display area between the front and rear substrates.

11. The PDP as claimed in claim 6, further comprising a first dielectric/protective layer on electrodes on the rear substrate and a second dielectric/protective layer on electrodes on the front substrate, wherein the frit and the second frit completely extend between the first dielectric/protective layer on the rear substrate and the second dielectric/protective layer on the front substrate.

12. The PDP as claimed in claim 1, wherein the non-display area is at an outer edge portion of the display area.

13. A plasma display panel (PDP), comprising:
front and rear substrates disposed to face each other;
a frit inserted between overlapping areas of the front and rear substrates;
a display area adapted to implement an image at the overlapping areas; and
a non-display area at an outer edge portion of the display area,
wherein the frit includes:
a first frit member at the non-display area, and
a second frit member at an outer side of the first frit member, and
the non-display area includes:
a first dummy barrier rib at an inner side of the first frit member and
a second dummy barrier rib between the first and second frit members.

14. The PDP as claimed in claim 13, wherein the second frit member is disposed at the outermost edge portion of the non-display area.

15. The PDP as claimed in claim 13, wherein a first width of the first frit member is smaller than a second width of the second frit member.

16. The PDP as claimed in claim 13, wherein a first gap between the front and rear substrates near the first frit member is larger than a second gap between the front and rear substrates near the second frit member.

17. The PDP as claimed in claim 13, wherein a number of first dummy barrier ribs is larger than a number of the second dummy barrier ribs.

18. The PDP as claimed in claim 13, wherein a first area where the first dummy barrier ribs are arranged is larger than a second area where the second dummy barrier ribs are arranged.

19. The PDP as claimed in claim 13, wherein the second frit member completely surrounds the display area and a portion of the non-display area between the front and rear substrates.

20. The PDP as claimed in claim 19, wherein the first frit member completely surrounds the display area and a respective portion of the non-display area between the front and rear substrates.
